(19) United States
(12) Patent Application Publication
(10) Pub. No.: US 2016/0184684 A1
(43) Pub. Date: Jun. 30, 2016

(54) System for Boxing and Athletic Training

(71) Applicant: Christopher Joseph Ray, Westerville, OH (US)

(72) Inventor: Christopher Joseph Ray, Westerville, OH (US)

(21) Appl. No.: 14/856,645

(22) Filed: Sep. 17, 2015

Related U.S. Application Data
(60) Provisional application No. 62/097,341, filed on Dec. 29, 2014.

(51) Int. Cl. A63B 69/20; F16M 11/18; F16M 11/00; A63B 69/00

(52) U.S. Cl. CPC A63B 69/20; A63B 69/004; A63B 69/201; A63B 69/205; F16M 11/18; F16M 11/00

(57) ABSTRACT

The present disclosure relates to a system of athletic training that comprises a plurality of boxing training aids. The system consists of two end frames which provide support for the system, and which provide mobility to the system through a series of casters. Two main beams connect the end frames, and support a number of training aids suspended between the beams. The system is made modular through the use of interchangeable connecting pieces, which allow for multiple system sections to be utilized simultaneously.

### CROSS-REFERENCE TO RELATED APPLICATIONS

This application claims priority to U.S. Provisional Patent Application Ser. No. 62/097,341 filed Dec. 29, 2014, the disclosure of which is hereby incorporated by reference.

### STATEMENT REGARDING FEDERALLY SPONSORED RESEARCH

Not applicable.

### BACKGROUND

The past few years have seen a rise in the popularity of dynamic exercise techniques. Martial arts, boxing, kickboxing, dynamic weightlifting, and other combined aerobic and high-impact exercises have become commonplace at many gyms. Such exercises are valued for their ability to build an athlete's strength as well as his or her cardiovascular endurance.

Gyms that offer training routines including boxing, kickboxing, or martial arts must provide their patrons with training aids suited to the activities. Two of the most common boxing training aids are the “heavy bag” and the “speed bag.” The heavy bag is a large cylindrical apparatus made to take heavy strikes from the user. The bags are traditionally covered in a canvas or polycanvas shell. The interior of the shell can be filled with a variety of fillers designed to absorb the impact of the strike by the user. Heavy bags vary in size, but usually range between 40 and 70 inches tall, 12 to 20 inches in diameter, and weigh between 60 and 100 pounds. Heavy bags are typically suspended from a ceiling or frame, and can be left to swing freely or can be anchored to the ground or a base to reduce the swinging of the bag when it is struck. The bag typically hangs from the frame or ceiling through a plurality of metal chains or straps made of nylon or canvas.

Whereas a heavy bag is meant to improve a user's strength and strike power, a speed bag is designed to train the user's hand speed. The speed bag is often made of similar materials to the heavy bag, but is significantly smaller. Speed bags range in size from 8 to 12 inches tall and 5 to 10 inches in diameter. The bag is suspended from a hook or other connector, which attaches to a swivel. The swivel is typically comprised of a small ball seated in an open base. When attached to the swivel, the bag has a wide range of motion, and is intended to return to the direction of the user once struck.

The industry offers a variety of products that serve as stands or frames to support boxing training aides. One style of stand comprises a frame that sits on the ground with a single overhanging beam to support the bag. Such a stand will commonly feature two legs running parallel to the ground, extending at 45-degree angles from the base of the stand, to prevent movement of the stand while the bag is in use. The “Heavy Bag Stand,” made by Balazs, Inc. of Allentown, Pa., is a good example of such a system. This style of stand is not ideal for use in a large gym setting, as each stand supports only a single bag, and each stand takes up a large amount of space.

The industry offers several products that are designed to support multiple bags at once. One such style of product comprises a pair of end frames that support a single crossbar spanning between the two end frames. The end frames each comprise two legs which extend outward from a central meeting point, and give stability to the frame overall. The central main beam is of a length sufficient to hold two or more boxing training bags, while allowing for reasonable space between the bags so that they may be used simultaneously. The “Standard A-Frame” product, made by Balazs, Inc. of Allentown, Pa. is an example of such a system. The “Huge Heavy Bag Stand” product, produced by the CSK brand, of Shandong, China, is an alternative model that is similar to the Balazs product.

The industry also offers products that are designed to support 4 or more training bags simultaneously. These products differ from those described above in that they are comprised of four leg sections, rather than two. Thus, the products result in a rectangular shape, with four beams spanning between the four legs. Each beam may be able to support 3 or more training bags, depending on the size of the system. The “Heavy Duty Complete Bag Stand” product of the Title Boxing brand, of Lenexa, Kans., and the “Zebra Multi Station Bag Rack” product of Zebra Mats, Inc. of Rogers, Minn. are two representative examples of such systems.

Of the products available in the market that allow for multiple boxing training bags to be used simultaneously, none is ideally suited for use in many of the dynamic training gyms that have recently become popular. Many athletes wish to switch between activities several times during a single exercise period. For example, an athlete may begin a workout with aerobic exercise, move to boxing training with a heavy bag, then to weight training, and then finish with a period of martial arts. As space in gyms is often limited, large boxing training products can be cumbersome and occupy valuable space when athletes are attempting to engage in other activities. The rise of boutique gyms occupying small spaces further heightens the need for a versatile training product that does not permanently occupy floor space.

The available combination training systems also lack the ability to expand their size to suit their users. Though products are available that support varying numbers of training bags simultaneously, none of the available products allow the user to expand the product so that it can support more bags than its original design. Such a feature would be valuable for gyms that might have varying numbers of athletes based on the time of the day or day of the week. Furthermore, a modular product would be superior to purchasing multiple independent frames because it could reduce cost for the purchaser, and could conserve space.

A product that improved on the deficiencies cited above would be novel to the industry and would be an improvement on the available products in the marketplace. A frame for supporting boxing training bags that was easily mobile would be ideal for use in small spaces and with dynamic training routines. A frame for supporting boxing training bags that was modular would also be an improvement, as it would allow a user to tailor his or her product to the needs of its athletes, while conserving valuable gym space and reducing costs for the user.

### BRIEF SUMMARY

The present disclosure relates to a training aid system to be used for sports such as boxing, kickboxing, or martial arts. The system improves upon similar products currently available in the marketplace through its mobility, and its character as a modular system. The system is well suited for users who have limited space in which to exercise, or for users who engage in dynamic training programs.

The basic elements of the system involve a strong metal frame that is capable of supporting a plurality of training aids. In the preferred embodiment, each section of the system supports three “heavy bag” boxing training aids, but the system is easily capable of supporting a variety of athletic training aids. The metal frame is comprised of two A-frame style pedestal pieces, which support an upper and lower interior beam. The end frame pieces consist of a central piece, which is connected to a base piece, with two small braces providing support to the central piece. The end frames provide structural support to the system.

The two interior beams support the training aids used in the system. When heavy bags are employed in the system, the upper interior beam supports the heavy bags through a plurality of metal chains or fabric straps. The lower interior beam provides stability to the heavy bags with a single connector acting as an anchor.

The four distal ends of the end frame pedestal pieces are fitted with casters, which provide mobility for the system. The system's mobility is an important feature, as it allows the system to be easily stored, or moved to best suit the athletes' needs, a feature not present in many similar products available in the marketplace.

The system is designed to be modular so it can adapt to changing numbers of athletes that may wish to use the system simultaneously. The end frames can be adjusted to support a connector piece that allows for additional system sections to be combined. Additional system sections sections can thus support the use of more training aids simultaneously than can be achieved through a base system section. The modular character of the system is unique to the industry as there are no similar products that can be easily expanded to accommodate varying numbers of athletes.

The disclosure provides for a training system that is well suited for modern dynamic training regimens. The system is unique to the industry due to its versatility. The system is mobile, and it can easily adapt its size and number of training aids to serve the needs of the user.

### BRIEF DESCRIPTION OF THE DRAWINGS

For a fuller understanding of the nature and advantages of the present invention, reference should be had to the following detailed description taken in connection with the accompanying drawings, in which:

FIG. 1 depicts a front view of the standard embodiment of a full system section;

FIG. 2 depicts a perspective view of one of the end-pedestal sections of the system;

FIG. 3 depicts a perspective view of a section of the system with one of the system attachments in use;

FIG. 4 depicts a detailed view of one of the system attachment sections; and

FIG. 5 depicts a detailed view of the reverse side of one of the system attachment sections.

### DETAILED DESCRIPTION

The present disclosure comprises a system serving as an athletic training aid designed for use by athletes practicing boxing, kickboxing, martial arts, or other similar athletic activities. The system is designed to allow multiple athletes to train simultaneously, by providing a plurality of training aids. The system can support a variety of boxing and martial arts training aids, including heavy bags, speed bags, and many other types of aids. The system is made mobile by the use of casters. The system is further designed to be modular to accommodate varying numbers of athletes and training practices.

The preferred embodiment of the system involves two end frames that support two main interior pieces, which in turn support the boxing training aids. In the preferred embodiment, the end frames comprise an “A-Frame” style pedestal structure, with a central vertical column connecting to a horizontal base piece running perpendicular to the base piece. Two braces extend from the base piece at angles and connect to the vertical piece to provide stability. Each of the end frame pieces is joined through the use of welding in the preferred embodiment.

Each end frame piece employs two industrial-grade casters at each distal end of the base piece of the frame, to provide mobility to the system. The casters can be locked when the system is in use by athletes, to prevent movement of the system, and can be unlocked when not in use. The mobility of the system allows the system to be stored when not being used, or to be moved to where it can best serve the athletes employing the system. The mobility of the system can allow the owner of the system to conserve space when it is not in use, and allow the owner to best meet the needs of the athletes who make use of the system.

The two end frames support two parallel interior pieces that in turn support the training equipment contained within the system. The upper main interior beam and lower main interior beam are joined with their respective portions of the end frame piece through a connector piece. The connector piece allows for entry of both the interior beams and the respective end frame pieces, and uses bolts to secure the pieces. When secured, the upper interior beam and the lower interior beam each extend between the two end frames, running parallel to one another.

The upper interior beam and lower interior beam support a plurality of boxing training aids between them. In the preferred embodiment, the upper and lower beams extend approximately ten feet, and support three training aids. The training aids are spaced evenly along the beams, approximately two to three feet apart. The space between the aids should be sufficient to allow athletes to train comfortably with each aid simultaneously.

When heavy bags are employed as the training aids, the bags are attached to the upper interior beam using a plurality of chains or straps made of vinyl or other similar material. The heavy bags may be attached to the lower interior beam using a single connector, however the system operates equally well if the bags are left to swing freely. If the bags are connected to the lower beam, the connection to the beam should be loose enough to allow the bag to have some limited range of motion, but should also prevent the bags from swaying or swinging excessively when it is struck.

A key aspect of the system is that the system is modular, and can support multiple attachment sections that greatly increase the versatility of the system. As many gyms experience variations in the number of patrons based on time of day or day of the week, and variations in preferred exercise routines for patrons, the ability to adapt the system to the daily circumstances is invaluable.

System attachment sections can be employed by adjusting the bolted connections of the end frame pieces. Whereas in the typical embodiment the system employs a single beam running between the end-pedestal sections of the system, one or more beam extensions can be employed at either distal end of the main upper beam, which can support additional training aids.

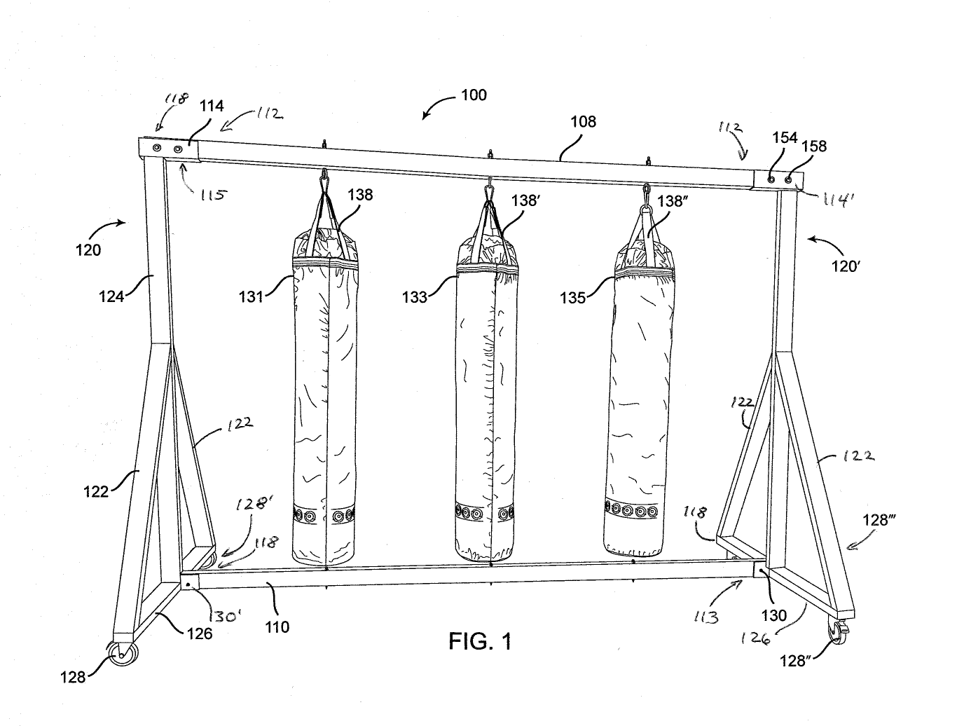

FIG. 1 depicts the preferred embodiment of a single base section of the athletic training system 100 as viewed from in front of the system. The basic aspects of the system are two A-frame pedestal sections at 120 and 120′ spanned by an elongated upper main beam 108 and an elongated lower main beam 110. These four components create a rectangular-shaped system when viewed from the front. The system is made mobile through the employment of four transport casters 128, 128′, 128″, 128″′, with two casters present at the base of each A-frame section.

As shown in FIG. 1, the present disclosure also comprises a modular apparatus for supporting athletic equipment, such as a heavy bag or other training equipment. The modular aspects of the frame allow for adding additional components, or extending the capacity (i.e., length) of the frame apparatus. As such, a frame such as that shown in FIG. 1 is formed of an A-frame pedestal apparatus (120) with a vertically oriented column (124) provided with fastener connections at the column top and at the column bottom, as at 114 and 130, for instance. The particular type of fastener connections used at a location can be modified, but in a preferred embodiment, the connection used with the upper cross beam and with the lower cross beam are incompatible with one another. Thus, the frame can be assembled in only one modular arrangement. The connections can be configured to be bolted, welded, or as detented sockets, with lock downs. In essence the fastener connections are compatible with the beam connector attaching a cross beam with the A-frame pedestal.

The A-frame pedestals 120 are comprised of a vertically oriented main column 124, a plurality of side braces providing support to the main column, shown at 122, and a horizontal cross beam 126 serving as the base of the pedestal. A single transport caster 128 is situated at each distal end of the horizontal base beam. As such, the A-frame pedestal will be provided with a horizontal cross beam (126), associated with transport casters (128) affixed to the lower portion of the horizontal cross beam, the cross beam connected perpendicularly with the vertical column (124), and both connected to a plurality of side braces (122) affixed to the horizontal cross beam at the lower end and to the column at the top end. In a preferred embodiment, the column, cross beam and two side braces are welded together to form a bisected triangle.

Each pedestal section must provide for an upper and lower main beam connector. Said connectors allow each pedestal section to connect with the upper main beam 108 and lower main beam 110 pieces. The upper main beam connector 114 joins the pedestal section to the upper main beam. The beam sections are joined through a plurality of bolted connections. The lower main beam connector is shown at 130. The lower main beam connector is shown with one bolted connection to the lower main beam.

The main beam connector pieces can be crafted in a variety of ways. As depicted in the figure, the upper main beam connector 114 is welded to the main column 124 of the end pedestal. The connector piece is then attached to the upper main beam through the depicted bolted connections. Likewise, the lower main beam connector 130 is depicted as being welded to the base beam 126 of the respective pedestal sections. Alternatively, the main beam connector pieces can be equally as effective when crafted differently. The upper main beam connector may be attached to the main column of the pedestals by bolted connectors rather than being welded to the column.

Attaching the main beam connector pieces through bolted connections rather than welds adds to the modular character of the system, as different connector pieces can easily be substituted to accommodate modular additions to base sections of the system. The A-frame pedestal can be attached to modular connectors, such as a lower main beam connector (130) attached to the horizontal cross beam (126), with the lower main beam connector (130) capable of accepting a lateral end (113) of a lower main beam (110). Further, an upper main beam connector (114) is attached by the fastener connections of the column, to be fixed to the top of the A-frame pedestal.

In an alternative embodiment, multiple system sections could be connected and used simultaneously by employing a different style of beam connector piece. The use of multiple system sections could allow a greater number of athletes to train using the system simultaneously.

The upper main beam connector is capable of accepting a lateral end of the upper main beam (108). As shown in FIG. 1, the upper main beam connector is configured to accept a single lateral end of an upper main beam. In keeping with the modular nature of the apparatus, the upper main beam connector can be modified as a bilateral connector, to accept the lateral ends of two upper main beams, thereby extending the length of the assembled apparatus. In a preferred embodiment, the system is provided with unilateral and bilateral upper main beam connectors, with the unilateral connectors forming the ends of an assembled frame, and the bilateral connectors being utilized as intermediate connectors in an extended frame. In a preferred embodiment, the elongated upper main beam is configured with three upper main beam attachment points for a heavy training bag.

The upper main beam 108 and lower main beam 110 of each system section support the athletic training devices to be employed by the user of the system. In FIG. 1, the system section is depicted as supporting three heavy bag boxing training aids 131, 133, 135. Each training aid is supported by a plurality of metal chains or fabric straps at 138, 138′, and 138″. Each set of straps must be able to support the weight of the training aid, which can reach up to 100 pounds, as well as the added force supplied by the athlete using the training aid. In the present embodiment, the heavy bags are depicted without a lower anchor connecting the bags to the lower main beam. As described above, the system can operate equally effectively with or without anchoring the bags.

Similarly to the upper main beam, the elongated lower main beam (110) is provided with three lower main beam attachment points for a heavy training bag, with the lower main beam attachment points being spaced compatibly with the upper main attachment points.

Thus, the upper main beam is installed in an upper main beam connector on two spaced apart A-frame pedestals, a lower main beam is installed in the lower main beam connector of the two spaced apart A-frame pedestals, forming a generally rectangular frame, supported at it ends by braced pedestals that limit deflection motion. A heavy training bag is attached at the top to the upper main beam, and at the bottom to the lower main beam, with the heavy bag thereby affixed to the assembled frame at the bag top and the bag bottom, and holding the heavy bag in a location for use by an athlete, and capable of resisting displacement when struck by the athlete. The assembled frame and heavy bags are generally portable by wheeling the apparatus about a flat athletic equipment area surface on the casters. In another embodiment of the apparatus, upper main beam bag connectors are fitted into the upper main beam attachment points, providing for the heavy bag to be removeably attachable to the frame.

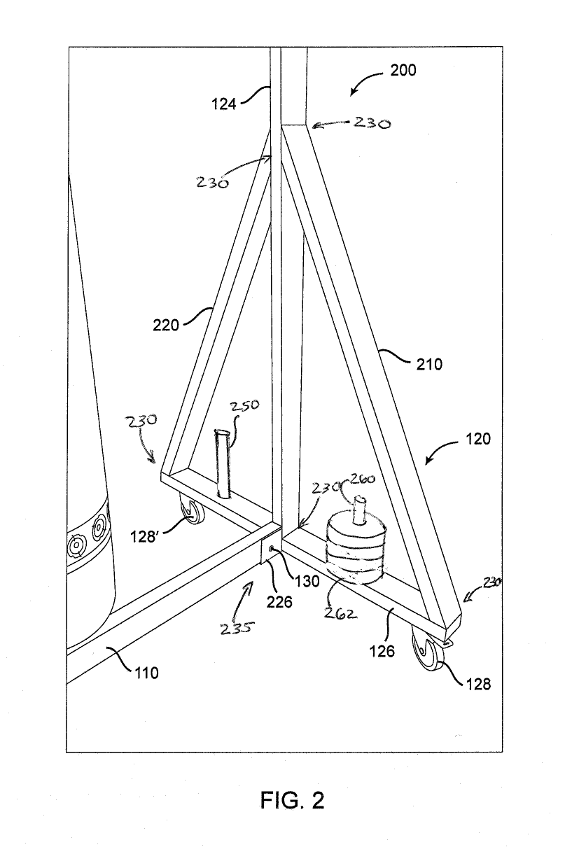

FIG. 2 depicts a perspective view 200 of one of the end pedestal sections 120 of the present system. The pedestal frame is comprised of a vertically oriented main column 124 and a horizontal cross beam 126 running perpendicular to the main column. The column meets the cross beam approximately at the midpoint of the cross beam. Two side braces 210, 220 extend from the distal ends of the horizontal cross beam and meet the vertical main column just past its midpoint. The side braces provide support to the main column and provide stability for the system as a whole. In the present embodiment, as shown in FIG. 2, the main column, cross beam and side braces are all joined by a series of metal welds, 230. Transport casters 128, 128′ are present at each distal end of the horizontal cross beam. The casters provide mobility to the system, and can be locked when the system is in use by athletes so the system remains stationary. The lower main beam is depicted at 110, and the lower main beam connector piece is shown at 226. The bolted connection, by way of fastener 130, between the lower main beam and the lower main beam connector is at 235.

A further feature of the system is supplying the A-frame pedestals of the apparatus shown in FIG. 2 with ballast holder pins for accepting ballast in the form of weight plates. Such ballast can serve to counterbalance forces applied to the system by users striking the heavy bags, for instance. Such ballast pins 250, 260 can be configured at a number of suitable locations on the apparatus, alternatively on the side braces, or the lower main beam. Ballast pin 260 is shown with four weight plates 262 in place.

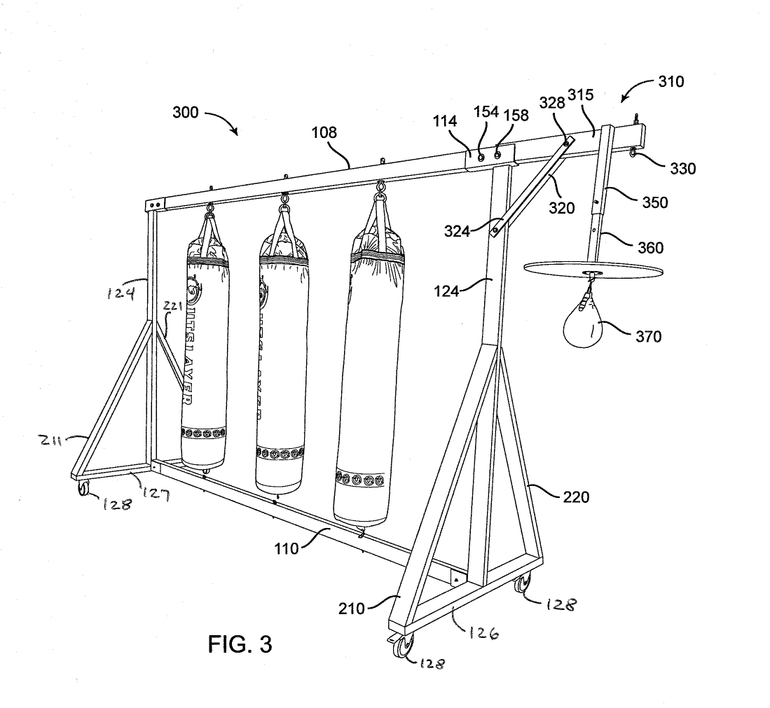

FIG. 3 depicts a perspective view of the system 300, with the system utilizing an attachment piece. As in FIG. 1, the upper main beam 108 supports a series of punching heavy bags, with the lower main beam 110 running underneath. The end pedestal section is depicted with main column 124 and two support braces at 210 and 220. The upper main beam connector 114 is attached to the upper main beam by bolted connectors 154 and 158.

In the present embodiment, an attachment section 310 extends out from the upper main beam, supported by an upper main beam extension piece 315. The extension piece is seated within the upper main beam connector piece, and is supported by two brace bars 320 running between the main column of the end pedestal and the upper main beam extension piece. The support bar is attached by two bolted connectors. The lower connector 324 joins the support bar to the main column 124 of the end pedestal section. The upper connector 328 joins the support bar to the body of the main beam extension piece.

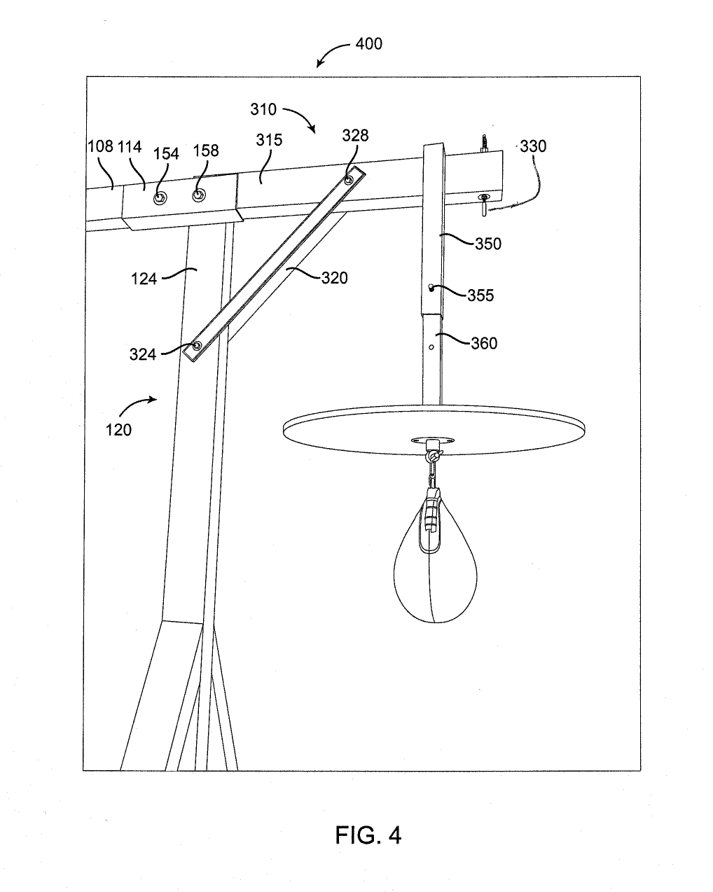

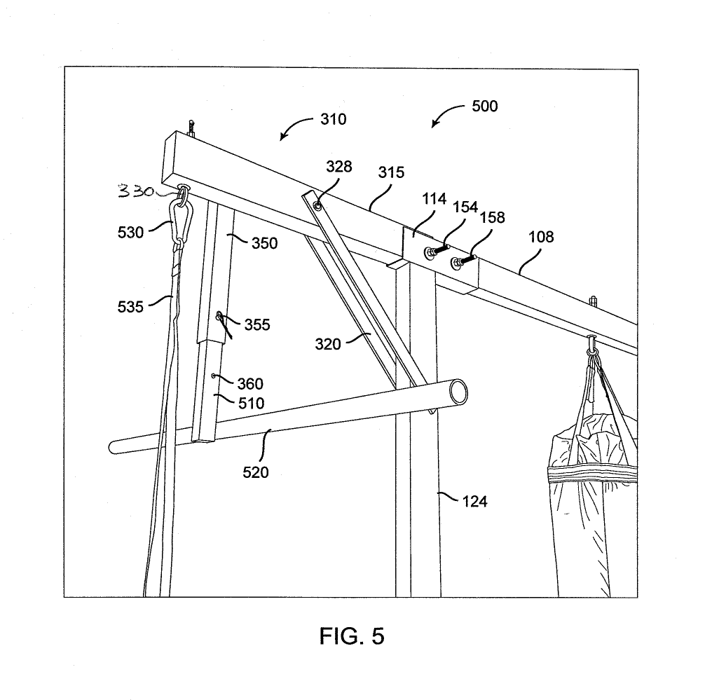

The upper main beam extension piece 315 supports a vertical bar 350 that can be used to support a variety of athletic training equipment. The vertical section is comprised of a permanent upper section and an interchangeable lower section 360. The two sections are joined by a removable pin connector. The pin connector is shown in detail in FIG. 4. In the present embodiment, the lower section is supporting a speed bag punching bag attachment. This section can also support a number of different athletic training attachments, including different sizes of punching bags, pull-up bars, abdominal straps, and others. A metal loop 330 is present at the distal end of the extension piece. The loop runs through the body of the beam and is secured with a bolt. This loop provides another means of attaching athletic training equipment to the system. The capabilities of the metal loop attachment are described in further detail in FIG. 5.

FIG. 4 depicts a detailed view of the attachment section 400 shown in FIG. 3. The upper main beam connector piece 114 is shown with bolted connections at 154 and 158. A portion of main beam 108 is visible. The main beam connector is welded to the main vertical column 124 of the end pedestal section 120. The attachment section 310 extends outward from the upper main beam, seated in the upper main beam connector. The upper main beam extension piece 315 is supported by two brace bars 320. The support braces are attached by bolted connections to the vertical pedestal piece 324 and the main beam extension piece 328. A vertical beam 350 extends down from the main beam extension. The vertical beam consists of a permanent section and replaceable lower section 360. The upper and lower sections of the vertical beam are joined using a metal pin connection at 355. In the present embodiment, the attachment section is depicted as supporting a speed bag punching bag attachment. A metal loop 330 is present at the distal end of the extension piece. The loop extends through the body of the extension piece and is secured with a bolt connection.

FIG. 5 depicts a reverse view 500 of an alternative embodiment of the attachment section of the system. As in FIG. 4, a vertical beam 350 extends down from the upper main beam extension piece 315. The permanent vertical beam is connected to the detachable portion of the vertical beam 510 through a pin connector 355. The pin connector consists of a metal pin with a removable pin lock. When the pin is removed, the lower portion of the vertical beam may be removed, and replaced with a number of compatible attachments.

In the present embodiment, a pull-up bar 520 attachment is utilized as the lower portion of the vertical beam attachment. As described above, the vertical beam attachment can support a variety of different athletic training aids. In addition to the speed bag punching bag and pull-up bar depicted in the present figures, the system is also compatible with attachments for other varieties of punching bags, and several types of different bodyweight training tools.

The metal loop attachment is shown at 330. A metal carabiner 530 is shown hooked through the loop attachment. With the carabiner, a number of different training aids can be utilized with the system. In the present embodiment, a series of exercise straps 535 are looped through the carabiner, extending downward. Exercise straps allow an athlete to perform a number of bodyweight exercises. The loop attachment can likewise be used with resistance training bands, athletic training ropes, and a number of other athletic training tools.

Since certain changes may be made in the above apparatus and method without departing from the scope of the disclosure herein involved, it is intended that all matter contained in the above description or shown in the accompanying drawings shall be interpreted as illustrative and not in a limiting sense.

1. A system for supporting athletic equipment comprising a frame formed of
an A-frame pedestal said pedestal further comprising
a vertically oriented column with fastener connections at the column top and at the column bottom,
a horizontal cross beam, said horizontal cross beam associated with transport casters on the lower portion of the horizontal cross beam,
a plurality of side braces affixed to the horizontal cross beam at the lower end and to the column at the top end,
a lower main beam connector attached to the horizontal cross beam, said lower main beam connector capable of accepting a lateral end of a lower main beam,
an upper main beam connector attached to the column, said upper main beam connector capable of accepting a lateral end of a lower main beam;
an elongated upper main beam with a plurality of upper main beam attachment points for a heavy training bag; and
an elongated lower main beam with a plurality of attachment points for a heavy training bag, said lower main beam attachment points being spaced compatibly with the upper main attachment points,
whereby an upper main beam is installed in an upper main beam connector on two A-frame pedestals, a lower main beam is installed in the lower main beam connector of the A-frame pedestals, a heavy training bag is attached at the top to the upper main beam, and at the bottom to the lower main beam, such that the heavy bag is supported by the assembled frame, said assembled frame being portable about an athletic equipment area.

2. The system of claim 1 further comprising an A-frame pedestal with attachable ballast holders.

3. The system of claim 1 further comprising a lower beam connector and an upper beam connector capable of accepting a plurality of beams.

4. A modular apparatus for supporting athletic equipment comprising a frame formed of
an A-frame pedestal apparatus said pedestal apparatus further comprising
a vertically oriented column with fastener connections at the column top and at the column bottom, said fastener connections compatible with a beam connector,
a horizontal cross beam, said horizontal cross beam associated with transport casters on the lower portion of the horizontal cross beam,
a plurality of side braces affixed to the horizontal cross beam at the lower end and to the column at the top end,
a lower main beam connector attached to the horizontal cross beam, said lower main beam connector capable of accepting a lateral end of a lower main beam,
an upper main beam connector attached to the fastener connections of the column, said upper main beam connector capable of accepting a lateral end of the lower main beam;
an elongated upper main beam with three upper main beam attachment points for a heavy training bag; and
an elongated lower main beam with three lower main beam attachment points for a heavy training bag, said lower main beam attachment points being spaced compatibly with the upper main beam attachment points,
whereby an upper main beam is installed in an upper main beam connector on two spaced apart A-frame pedestals, a lower main beam is installed in the lower main beam connector of the two spaced apart A-frame pedestals, a heavy training bag is attached at the top to the upper main beam, and at the bottom to the lower main beam, such that the heavy bag is affixed at the bag top and affixed at the bag bottom to the assembled frame, holding the heavy bag in a location for use by an athlete, and capable of resisting displacement when struck by the athlete, said assembled frame being portable on the casters about an athletic equipment area.

5. The apparatus of claim 4 further comprising upper main beam bag connectors fitting into upper main beam attachment points, said bag connectors removeably attachable without the use of tools.

6. The apparatus of claim 4 further comprising A-frame pedestals with ballast holder pins for accepting ballast in the form of weight plates.

7. The apparatus of claim 4 further comprising a modular unit consisting of an A-frame pedestal, a second upper main beam, and a second lower main beam, which when assembled with the apparatus of claim 4 extends the assembled frame to accommodate supporting additional heavy training bags.

8. The apparatus of claim 4 further comprising a variety of heavy training bags in the form of one or more of a heavy training bag, a speed bag platform, a kick-boxing target, a punching bag, and other athletic training aids.

9. The apparatus of claim 4 further comprising an A-frame pedestal with the column, cross beam and side braces formed of tubular steel and attached to one another by welding.

10. The apparatus of claim 4 further comprising a kit for extending the length of the assembled frame, said kit further comprising, one or more A-frame pedestals, one or more beams, two or more beam connectors and fasteners in the form of locking bolts.

11. A kit for providing a system for supporting athletic equipment comprising a group of parts for assembly, said group including
one or more of an A-frame pedestal said pedestal further comprising a vertically oriented column, a pedestal horizontal cross beam, said horizontal cross beam associated with transport casters on the lower portion of the horizontal cross beam, a plurality of side braces affixed to the horizontal cross beam at the lower end and to the column at the top end, a lower main beam connector attached to the horizontal cross beam, said lower main beam connector capable of accepting at least one lateral end of a lower main beam, an upper main beam connector attached to the column, said upper main beam connector capable of accepting a lateral end of a lower main beam;
one or more of an elongated upper main beam with a plurality of upper main beam attachment points for a heavy training bag;
one or more of an elongated lower main beam with a plurality of attachment points for a heavy training bag, said lower main beam attachment points being spaced compatibly with the upper main attachment points; and
fasteners for connecting the upper main beam and the lower main beam to the A-frame pedestal through use of the upper main beam connector and the lower main beam connector,
whereby an upper main beam is installed in an upper main beam connector on two A-frame pedestals, a lower main beam is installed in the lower main beam connector of two A-frame pedestals, a heavy training bag is attached at the top to the upper main beam, and at the bottom to the lower main beam, such that the heavy bag is supported by the assembled frame, said assembled frame being portable about an athletic equipment area.

12. The kit of claim 11 further comprising one A-frame pedestal, one upper main beam and two lower main beams.

13. The kit of claim 11 further comprising two A-frame pedestals, one upper main beam and two lower main beams.

14. The system of claim 1 further comprising an extension piece attachable to within the upper main beam connector, supported by two brace bars that can extend from the pedestal vertical column to the extension piece.

15. The system of claim 14 further comprising a vertical bar for supporting athletic equipment attached to the extension piece, said vertical bar formed with an interchangeable lower bar section.

16. The apparatus of claim 4 further comprising an extension piece attachable to within the upper main beam connector, supported by two brace bars that can extend from the pedestal vertical column to the extension piece.

17. The apparatus of claim 16 further comprising a vertical bar for supporting athletic equipment attached to the extension piece, said vertical bar formed with an interchangeable lower bar section.
